(19) United States
(12) Patent Application Publication
(10) Pub. No.: US 2015/0004460 A1
(43) Pub. Date: Jan. 1, 2015

(54) BATTERY WITH THREE-DIMENSIONAL CAP AND SWITCH

(71) Applicant: Sihui Han, Rancho Cucamonga, CA (US)

(72) Inventor: Sihui Han, Rancho Cucamonga, CA (US)

(21) Appl. No.: 13/929,409

(22) Filed: Jun. 27, 2013

(51) Int. Cl. H01M 2/10; H01M 2/30

(52) U.S. Cl. CPC H01M 2/1055; H01M 2/30; H01M 2220/30
USPC 429/123

(57) ABSTRACT

A battery may include a battery body; a three-dimensional cap coupled with the battery body, and having a protruding portion to separate positive and negative electrodes of the battery; and a switch, wherein the battery is allowed to directly coupled and used with other electronic devices such as flashlights and electronic cigarettes without using a battery container or holder. In one embodiment, the three-dimensional cap can be coupled with a semi-finished battery product containing electrolyte.

### FIELD OF THE INVENTION

The present invention relates to a battery, and more particularly to a battery with a three-dimensional cap and switch.

### BACKGROUND OF THE INVENTION

A battery is a device consisting of one or more electrochemical cells that convert stored chemical energy into electrical energy. Since the invention of the first battery in 1800, batteries have become a common power source for many household and industrial applications.

The battery usually consists of a number of voltaic cells; each voltaic cell consists of two half-cells connected in series by a conductive electrolyte containing anions and cations. One half-cell includes electrolyte and the electrode to which anions (negatively charged ions) migrate, i.e., the anode or negative electrode, and the other half-cell includes electrolyte and the electrode to which cations (positively charged ions) migrate, i.e., the cathode or positive electrode. In the redox reaction that powers the battery, cations are reduced (electrons are added) at the cathode, while anions are oxidized (electrons are removed) at the anode. The electrodes do not touch each other but are electrically connected by the electrolyte. Some cells use two half-cells with different electrolytes. A separator between half-cells allows ions to flow, but prevents mixing of the electrolytes.

However, the positive and negative electrodes of conventional batteries are disposed at two ends thereof, so conventional batteries cannot be used directly. More specifically, to use conventional batteries, they have to be disposed in a container or holder, so that the positive and negative electrodes can be safely disposed to connect and power an electronic device, which may cause certain level of inconvenience to the users. Thus, there remains a need for a new and improved battery that can overcome the problem stated above.

### SUMMARY OF THE INVENTION

It is an object of the present invention to provide a battery with a three-dimensional cap and switch that is small, light and can be used directly to couple with other electronic devices.

It is another object of the present invention to provide a battery with a three-dimensional cap and switch wherein positive and negative electrodes can be disposed at the same end without safety concerns.

In one aspect, a battery in the present invention may include a battery body, a three-dimensional cap and a switch. The battery may include just the battery body and the three-dimensional cap. In one embodiment, the battery body can be an existing shell of a conventional battery, and the three-dimensional cap can be a flat cap of the conventional battery couple with a three-dimensional tube.

In another embodiment, the switch can be disposed at a top portion of the three-dimensional cap. In still another embodiment, the top portion of the three-dimensional cap has threads or slots corresponding to the electronics coupled therewith.

In a further embodiment, the switch can be a button. In still a further embodiment, the switch can be a sliding switch or a flipping switch. In some embodiments, the switch can be controlled by voice, and in other embodiments, the switch can be controlled by light.

### BRIEF DESCRIPTION OF THE DRAWINGS

FIG. 1 illustrates a schematic view of a battery with a three-dimensional cap and switch in the present invention.

FIG. 2 illustrates a schematic view of a conventional battery.

FIG. 3 illustrates a schematic view of one embodiment of the battery in the present invention.

FIG. 4 illustrates a schematic view of another embodiment of the battery in the present invention.

FIG. 5 illustrates a schematic view of a further embodiment of the battery in the present invention.

FIG. 6 illustrates a schematic view of a portable soldering device coupled with the battery in the present invention.

FIG. 7 illustrates a schematic view of a flashlight coupled with the battery in the present invention.

FIG. 8 illustrates a schematic view of an electronic cigarette coupled with the battery in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

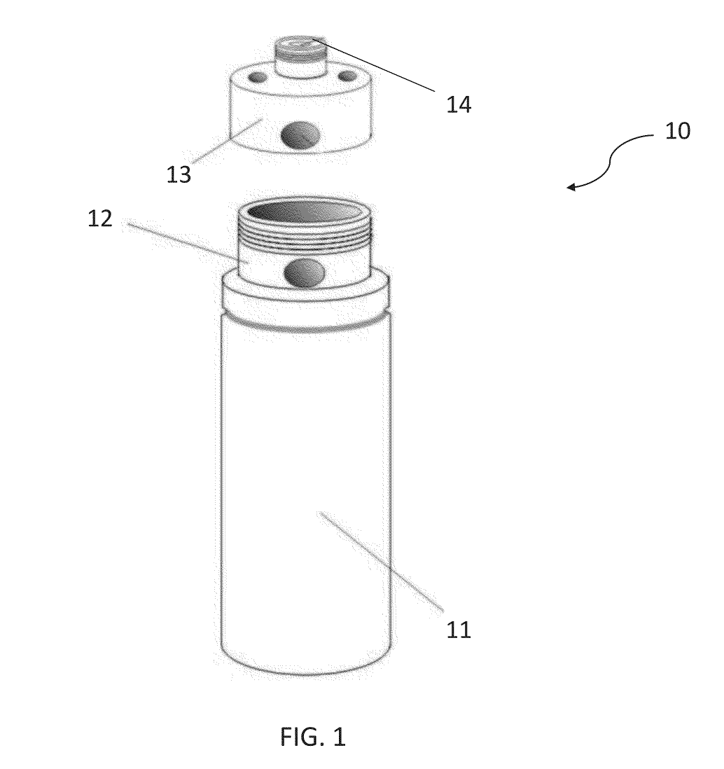

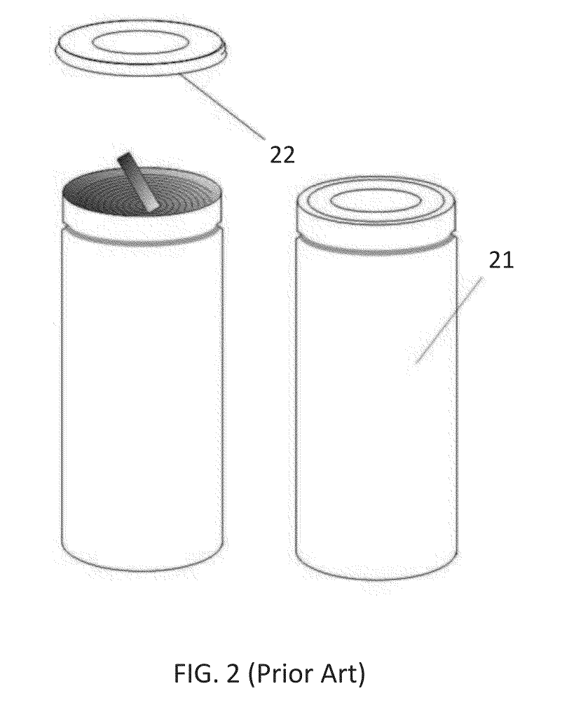

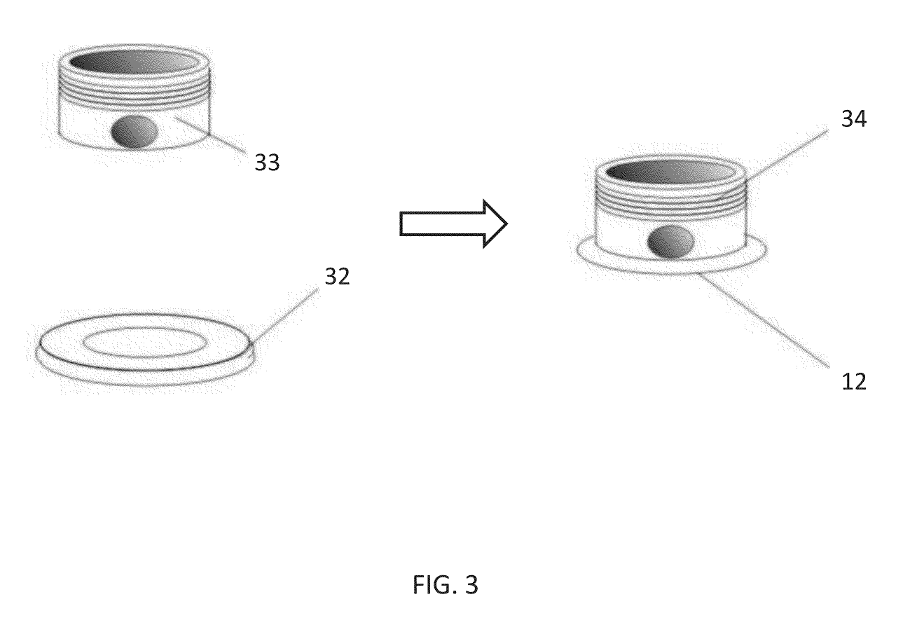

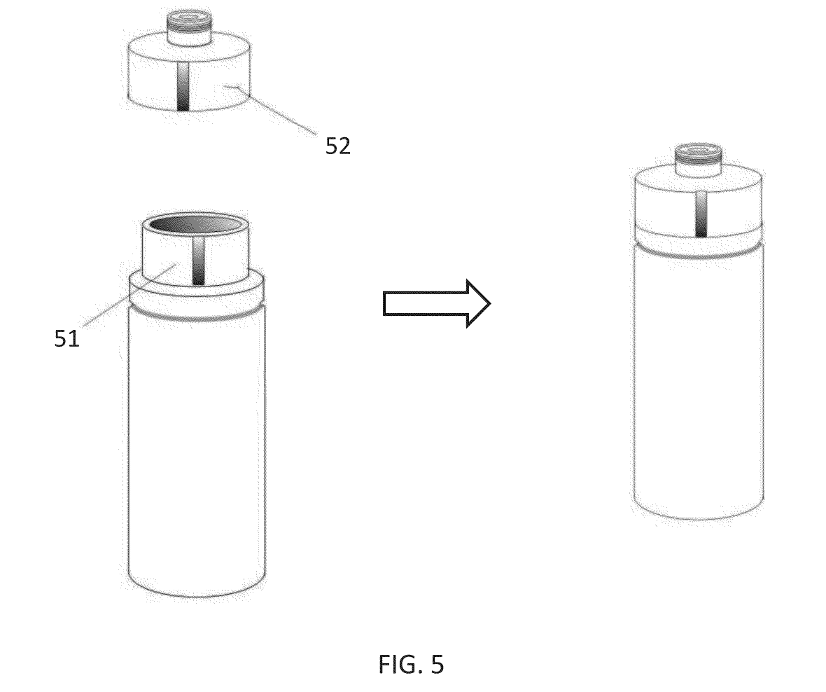

As shown in FIG. 1, a battery (10) may include a battery body (11), a three-dimensional cap (12) and a switch (13). The battery may include just the battery body (11) and the three-dimensional cap (12). In one embodiment, the battery body (11) can be an existing shell (21) of a conventional battery, and the three-dimensional cap (12) can be a flat cap (22) of the conventional battery couple with a three-dimensional tube (33), as shown in FIGS. 2 and 3. In another embodiment, the three-dimensional cap (12) can be a plastic gasket (32) coupled with the three-dimensional tube (33). In still another embodiment, the switch (13) can be disposed at a top portion of the three-dimensional cap (12). In a further embodiment, the top portion of the three-dimensional cap (12) has threads (34) or slots (51 shown in FIG. 5) corresponding to the electronics coupled therewith.

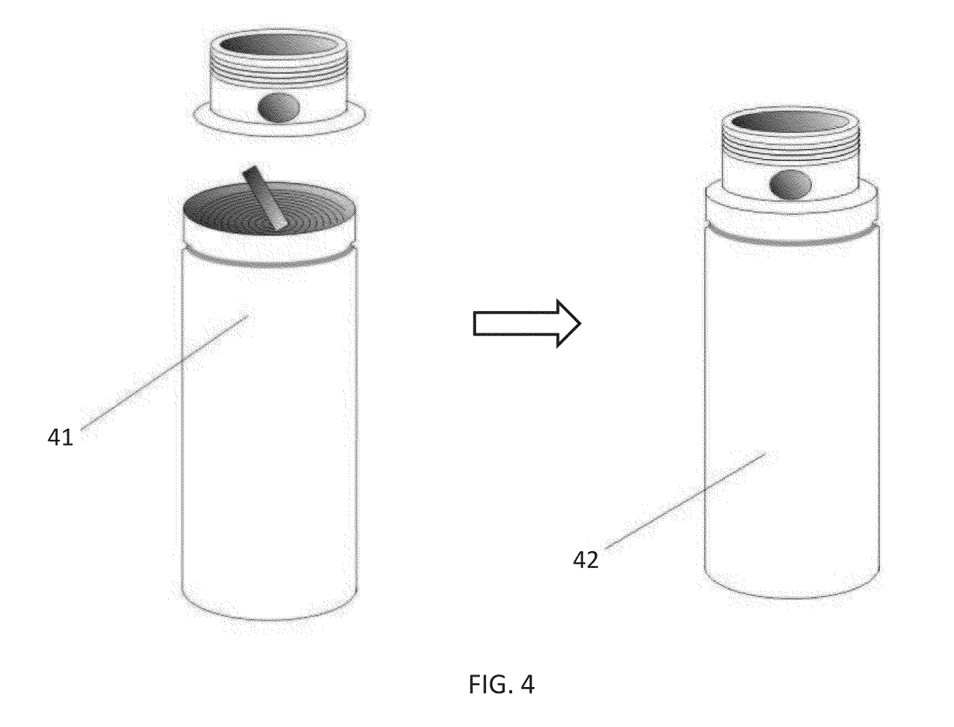

Referring to FIGS. 2 and 4, the three-dimensional cap (12) can be coupled with a semi-finished battery product (41) containing electrolyte as conventional batteries. Furthermore, the process to manufacture a battery (42) with the three-dimensional cap (12) is identical with the manufacturing process of conventional batteries, so there is no safety concerns. The positive and negative electrodes of conventional batteries are disposed at two ends thereof, so conventional batteries cannot be used directly. More specifically, to use conventional batteries, they have to be disposed in a container or holder, so that the positive and negative electrodes can be safely disposed to connect and power an electronic device. In the present invention, since a protruding portion (14) of the three-dimensional cap (12) naturally separates the positive and negative electrodes, the battery (42) with the three-dimensional cap (12) is safe to use without using the battery container or holder as conventional batteries.

In another embodiment, the battery in the present invention has the switch (13) to solve the problem of installing protection devices and control boards. An inner space is created in the battery (42) with the three-dimensional cap (12) and the switch (13), so installing protection devices and control boards becomes easier without soldering.

Furthermore, the style of the switch (13) and the three-dimensional cap (12) can be changed. In one embodiment, the switch (13) can be a button. In another embodiment, the switch (13) can be a sliding switch or a flipping switch. In a further embodiment, the switch (13) can be controlled by voice. In still a further embodiment, the switch (13) can be controlled by light.

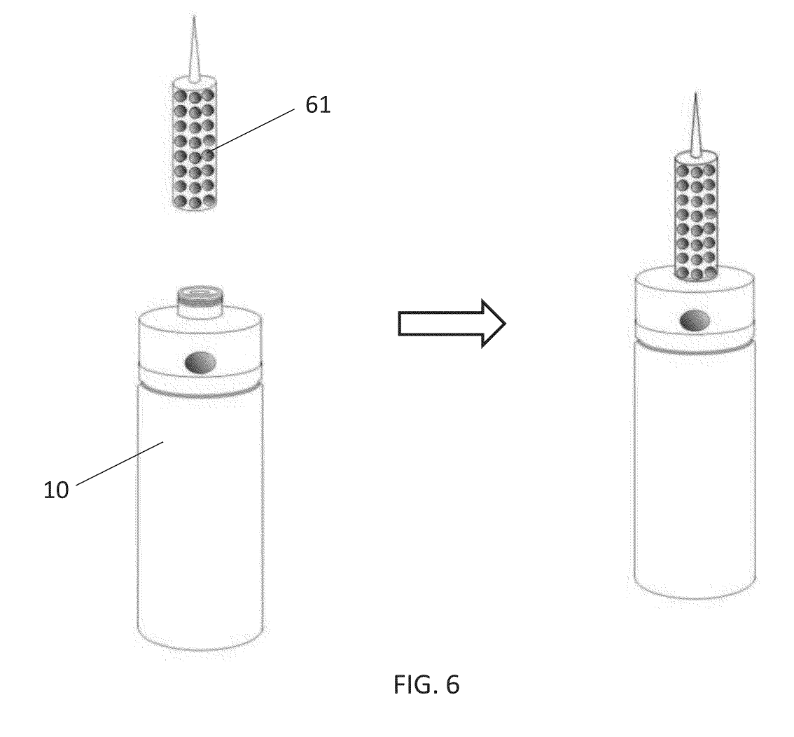

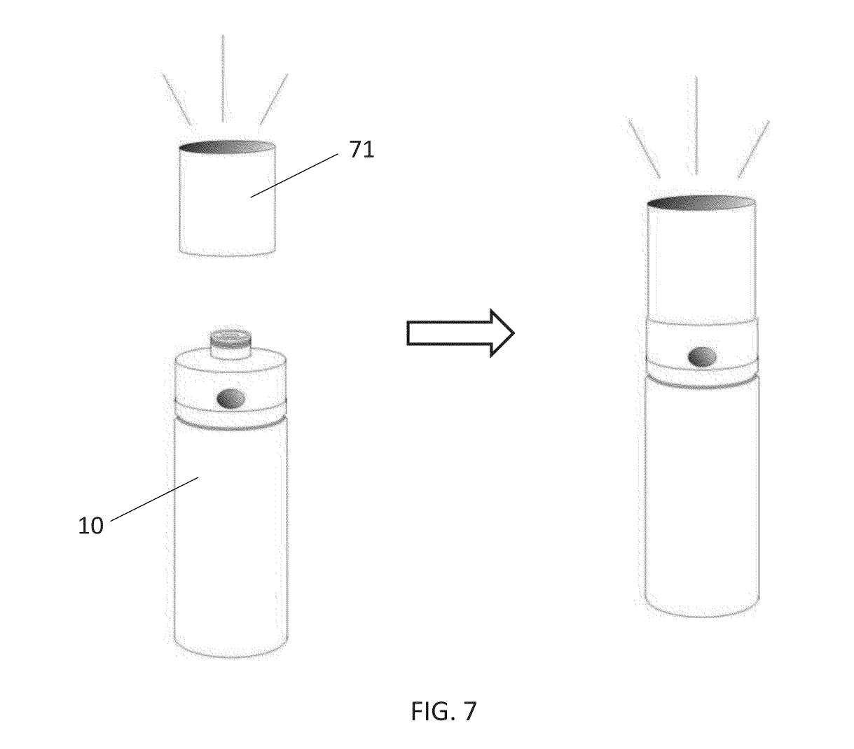

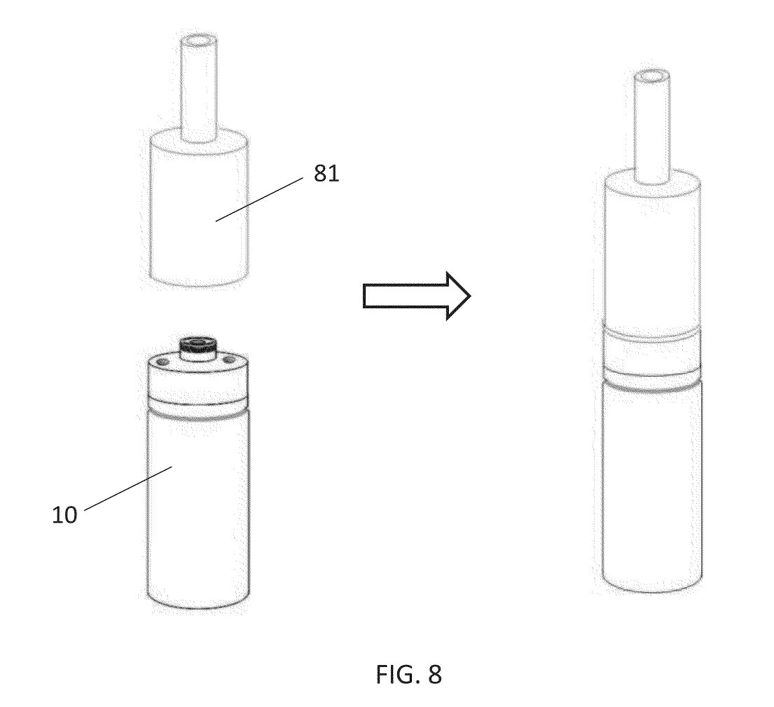

The battery in the present invention can be easily coupled with existing electronic devices. For example, as shown in FIG. 6, the battery (10) can be directly coupled with a portable soldering device (61) without using conventional battery containers or holders. Similarly, as shown in FIGS. 7 and 8, the battery (10) in the present invention can be coupled with a flashlight (71) and an electronic cigarette (81).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A battery comprising a battery body; a three-dimensional cap coupled with the battery body, and having a protruding portion to separate positive and negative electrodes of the battery; and a switch, wherein the battery is allowed to directly coupled and used with other electronic devices without using a battery container or holder.

2. The battery of claim 1, wherein the three-dimensional cap is allowed to couple with a semi-finished battery product containing electrolyte to form the battery.

3. The battery of claim 1, wherein an inner space is created in the battery with the three-dimensional cap and the switch, so installing protection devices and control boards becomes easier without soldering.

4. The battery of claim 1, wherein the switch is a button.

5. The battery of claim 1, wherein the switch is a sliding switch, a flipping switch or the like.

6. The battery of claim 1, wherein the switch is controlled by sound.

7. The battery of claim 1, wherein the switch is controlled by light,
